(19) United States
(12) Patent Application Publication
(10) Pub. No.: US 2025/0308787 A1
(43) Pub. Date: Oct. 2, 2025

(54) ELECTRONIC DEVICE

(71) Applicant: TDK Corporation, Tokyo (JP)

(72) Inventors: Ryota NAMIKI, Tokyo (JP); Toshihiro IGUCHI, Tokyo (JP); Kenya TAMAKI, Tokyo (JP); Kengo AIZAWA, Tokyo (JP); Naoki HAYAKAWA, Tokyo (JP)

(73) Assignee: TDK Corporation, Tokyo (JP)

(21) Appl. No.: 19/046,706

(22) Filed: Feb. 6, 2025

(30) Foreign Application Priority Data
Mar. 27, 2024 (JP) 2024-052261
Jan. 22, 2025 (JP) 2025-009382

(51) Int. Cl. H01G 4/12; H01G 4/008; H01G 4/012; H01G 4/30

(52) U.S. Cl. CPC H01G 4/1236; H01G 4/008; H01G 4/012; H01G 4/30

(57) ABSTRACT

An electronic device includes an element body including a ceramic layer and an internal electrode layer being laminated. The ceramic layer contains a main component including Ca and/or Sr and Zr. The element body includes a localized layer where Mn is localized in a layer-like manner along a lamination interface between the ceramic layer and the internal electrode layer.

The present application claims a priority to Japanese patent application No. 2024-052261 filed on Mar. 27, 2024 and Japanese patent application No. 2025-009382 filed on Jan. 22, 2025, which is incorporated herein by reference in its entirety.

### TECHNICAL FIELD

The present invention relates to an electronic device including a ceramic layer and an internal electrode layer.

### BACKGROUND

Known is a multilayer ceramic electronic device in which ceramic layers composed of a dielectric composition and internal electrode layers are alternately laminated. The ceramic layers and the internal electrode layers of this multilayer ceramic electronic device have differences in characteristics, such as shrinkage factor and linear thermal expansion coefficient. Thus, due to these differences in characteristics, structural defects (e.g., cracks) readily occur at interfaces between the ceramic layers and the internal electrode layers; and this tendency is particularly noticeable in a high-temperature and high-humidity environment.

In this regard, for example, Patent Document 1 (JP Patent Application Laid Open No. 2014-123698) discloses a method of reducing the number of cracks after firing by forming a secondary phase material at interfaces between internal electrodes and dielectric layers; however, research in terms of a high-temperature and high-humidity environment has not been conducted.

### SUMMARY

The present invention has been achieved in view of such circumstances. It is an object of the invention to provide an electronic device capable of having fewer cracks in a high-temperature and high-humidity environment.

To achieve the above object, an electronic device according to the present invention is an electronic device including an element body including a ceramic layer and an internal electrode layer being laminated, wherein the ceramic layer contains a main component including Ca and/or Sr and Zr, and the element body includes a localized layer where Mn is localized in a layer-like manner along a lamination interface between the ceramic layer and the internal electrode layer.

Because the element body of the electronic device of the present invention includes the predetermined localized layer, cracks can be prevented or reduced in a high-temperature and high-humidity environment.

Preferably, LMn, CMn, and IMn satisfy CMn<LMn and IMn<LMn, where
LMn denotes a Mn content of the localized layer in terms of a Mn oxide out of a total of 100 parts by mol Al, Si, Ca, Ti, Mn, Ni, Sr, and Zr in terms of their oxides in the localized layer,
CMn denotes a Mn content of the ceramic layer in terms of the Mn oxide out of a total of 100 parts by mol Al, Si, Ca, Ti, Mn, Ni, Sr, and Zr in terms of their oxides in the ceramic layer, and
IMn denotes a Mn content of the internal electrode layer in terms of the Mn oxide out of a total of 100 parts by mol Al, Si, Ca, Ti, Mn, Ni, Sr, and Zr in terms of their oxides in the internal electrode layer.

This can further prevent or reduce cracks in a high-temperature and high-humidity environment.

Preferably, the localized layer contains Mn most among Al, Mg, Si, and Mn in terms of their oxides.

This can further prevent or reduce cracks in a high-temperature and high-humidity environment.

Preferably, LMn is 0.5 parts by mol or more and 12.0 parts by mol less, where LMn denotes a Mn content of the localized layer in terms of a Mn oxide out of a total of 100 parts by mol Al, Si, Ca, Ti, Mn, Ni, Sr, and Zr in terms of their oxides in the localized layer.

This can further prevent or reduce cracks in a high-temperature and high-humidity environment.

Preferably, LMn/CMn is 1.25 or more and 15.0 or less, where
LMn denotes a Mn content of the localized layer in terms of a Mn oxide out of a total of 100 parts by mol Al, Si, Ca, Ti, Mn, Ni, Sr, and Zr in terms of their oxides in the localized layer, and
CMn denotes a Mn content of the ceramic layer in terms of the Mn oxide out of a total of 100 parts by mol Al, Si, Ca, Ti, Mn, Ni, Sr, and Zr in terms of their oxides in the ceramic layer.

This can further prevent or reduce cracks in a high-temperature and high-humidity environment.

Preferably, the localized layer has a thickness of 0.1 nm to 14 nm.

This can further prevent or reduce cracks in a high-temperature and high-humidity environment.

Preferably, a coverage ratio of the localized layer is 80% or more; and the coverage ratio of the localized layer denotes a ratio of a total length of the localized layer in contact with the internal electrode layer along the lamination interface to a total length of the internal electrode layer along the lamination interface in a predetermined field of view of a section parallel to a lamination direction of the element body during observation of the internal electrode layer and the localized layer in pairs in contact with each other.

This can further prevent or reduce cracks in a high-temperature and high-humidity environment.

Preferably, a coverage ratio of the internal electrode layer is 90% or more; and the coverage ratio of the internal electrode layer denotes a ratio of a total length of the internal electrode layer along the lamination interface to a total length of the ceramic layer along the lamination interface in a predetermined field of view of a section parallel to a lamination direction of the element body during observation of the ceramic layer and the internal electrode layer in pairs in contact with each other.

Preferably, a main component of a conductive material included in the internal electrode layer includes Ni and/or a Ni based alloy.

This can further prevent or reduce cracks in a high-temperature and high-humidity environment.

Preferably, the ceramic layer contains a perovskite-type compound having a main component represented by a formula ABO₃; and the perovskite-type compound includes a compound representable by a composition formula (Ca₁₋ₓSrₓ)ₘ(Zr_{1-y-z}Ti_{y}Hf_{z})O₃, where
m ranges from 0.9 to 1.1,
x satisfies 0≤x≤1, and
y and z satisfy 0.80≤1−y−z≤1.0.

### BRIEF DESCRIPTION OF THE DRAWING(S)

FIG. 1A is a sectional view of a multilayer ceramic capacitor according to one embodiment of the present invention.

FIG. 1B is a sectional view of the multilayer ceramic capacitor along a line IB-IB shown in FIG. 1A.

FIG. 2 is an enlarged sectional view of a main part of FIG. 1A.

FIG. 3A is a photograph according to an example of the present invention.

FIG. 3B is a graph according to the example of the present invention.

FIG. 4 is a graph according to a comparative example of the present invention.

### DETAILED DESCRIPTION

Hereinafter, the present invention is described in detail with reference to an embodiment illustrated in the drawings.

### First Embodiment

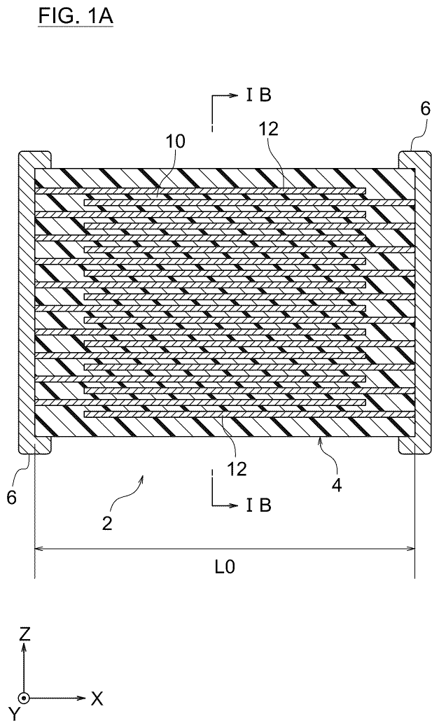

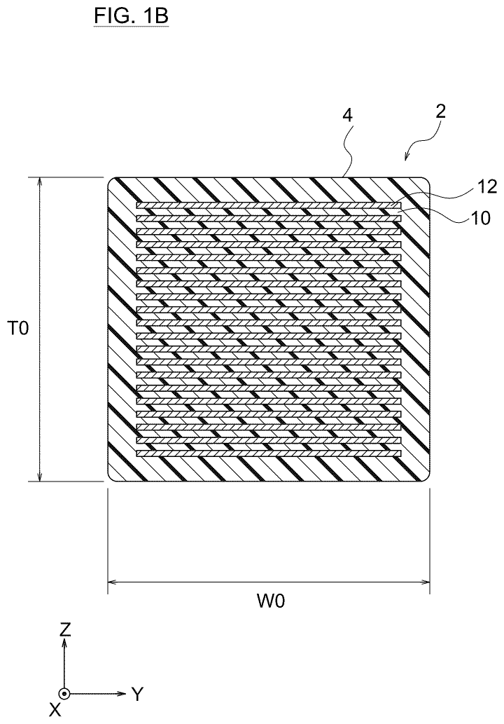

In the present embodiment, a multilayer ceramic capacitor 2 shown in FIGS. 1A and 1B is described as an example electronic device according to the present invention. The multilayer ceramic capacitor 2 includes an element body 4 and a pair of external electrodes 6 formed on outer surfaces of the element body 4.

The element body 4 shown in FIGS. 1A and 1B normally has a substantially rectangular parallelepiped shape. The element body 4 may have any other shape, such as an elliptic cylindrical shape, a cylindrical shape, or a prismatic shape. The element body 4 may have any external dimensions. For example, the element body 4 can have a length L0 of 0.4 mm to 5.7 mm in the X-axis direction, a width W0 of 0.2 mm to 5.0 mm in the Y-axis direction, and a height TO of 0.2 mm to 3.0 mm in the Z-axis direction.

In the present embodiment, the X-axis, the Y-axis, and the Z-axis are perpendicular to each other.

The element body 4 includes ceramic layers 10 (dielectric layers 10) and internal electrode layers 12 substantially parallel to a plane containing the X-axis and the Y-axis. Inside the element body 4, the ceramic layers 10 and the internal electrode layers 12 are alternately laminated along the Z-axis direction. In this context, “substantially parallel” means that the ceramic layers 10 and the internal electrode layers 12 are mostly parallel to the plane but may partly be slightly nonparallel. The ceramic layers 10 and the internal electrode layers 12 may be slightly uneven or inclined.

The ceramic layers 10 contain a main component preferably including Ca and/or Sr and Zr or more preferably including a perovskite-type compound represented by a formula ABO₃. The main component of the ceramic layers 10 means a component, composed of the main component's constituent elements, constituting a total of 80 parts by mol or more out of a total of 100 parts by mol of all constituent elements of the ceramic layers 10. In the present embodiment, the A-site of the perovskite-type compound preferably includes at least Ca and Sr; or the perovskite-type compound is more preferably a compound (hereinafter referred to as “CSZT based compound”) that can be represented by a composition formula (Ca₁₋ₓSrₓ)ₘ(Zr_{1-y-z}Ti_{y}Hf_{z})O₃. In the composition formula, x, y, z, and m are elemental ratios; and each elemental ratio is not limited and can be determined within a known range.

For example, m represents the elemental ratio of the A-site to the B-site and can normally range from 0.9 to 1.1. Also, x represents the elemental ratio of Sr in the A-site and can satisfy 0≤x≤1. That is, the ratio of Ca to Sr is determined freely; and it may be that only either of them is contained.

Also, y represents the elemental ratio of Ti in the B-site, and z represents the elemental ratio of Hf in the B-site. That is, 1−y−z represents the elemental ratio of Zr in the B-site. In the present embodiment, 0.80≤1−y−z≤1.0 is preferably satisfied. In a situation where the elemental ratio of Zr is within the above range, high-temperature load life at a high voltage is improved, and the crack occurrence rate can further be reduced.

The elemental ratio of oxygen (O) in the above composition formula may slightly deviate from the stoichiometric composition.

Other than the above main component, the ceramic layers 10 may also contain subcomponents. Examples of subcomponents include a Mn compound, a Si compound, an Al compound, a Mg compound, a Ni compound, a Li compound, and a B compound. There is no limit to the type, combination, or content of the subcomponents.

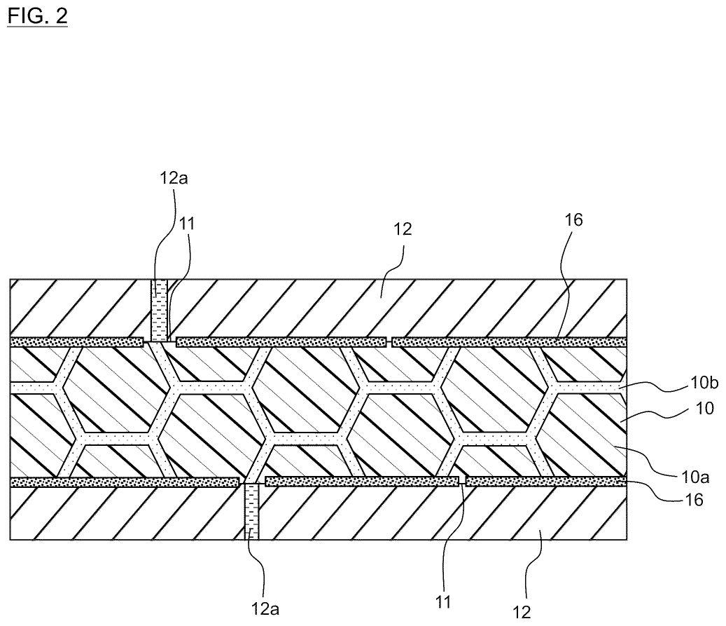

The ceramic layers 10 include, as shown in FIG. 2, main phase grains 10a composed of an oxide that is composed of the CSZT based compound and has a perovskite-type crystal structure and a grain boundary 10b. The grain boundary 10b may include segregate grains (not shown in the drawings) having a composition different from that of the main phase grains 10a. The above subcomponents of the ceramic layers 10 may be contained in the main phase grains 10a by being solid-dissolved therein, may be contained in the grain boundary 10b, or may be contained in the segregate grains.

The ceramic layers 10 may have any average thickness Td (interlayer thickness) per layer. For example, the average thickness can be 40 μm or less or is preferably 20 μm or less. The number of the ceramic layers 10 is determined according to desired characteristics and is not limited. The number of the ceramic layers 10 can be, for example, 20 or more or preferably 50 or more.

The internal electrode layers 12 are laminated between the ceramic layers 10. The number of the internal electrode layers 12 is determined according to the number of the ceramic layers 10. The internal electrode layers 12 may have any average thickness Te per layer. The average thickness is preferably, for example, 3.0 μm or less.

The internal electrode layers 12 are laminated so that their ends are exposed alternately to two end surfaces of the element body 4 facing each other in the X-axis direction. The external electrodes 6 are formed on the respective end surfaces of the element body 4 and are electrically connected to the exposed ends of the alternately arranged internal electrode layers 12. The internal electrode layers 12 and the external electrodes 6 formed in such a manner constitute a capacitor circuit.

Note that, as shown in FIGS. 1A and 1B, the internal electrode layers 12 are present not only along the X-axis direction but also along the Y-axis direction. Therefore, even if the internal electrode layers 12 look discontinuous along the X-axis in a sectional view parallel to a Z-X plane of the multilayer ceramic capacitor 2, the internal electrode layers 12 are in fact electrically continuous through their portions present along the Y-axis direction. Such portions where the internal electrode layers 12 look discontinuous in a section parallel to the lamination direction are hereinafter referred to as electrode discontinuous portions 12a.

The existence ratio of the electrode discontinuous portions 12a can be determined from the coverage ratio of the internal electrode layers. The coverage ratio of the internal electrode layers is, in a predetermined field of view of a section (Y-Z plane or Z-X plane) parallel to the lamination direction (Z-axis direction) of the element body 4 during observation of one ceramic layer 10 and one internal electrode layer 12 in pairs in contact with each other, the ratio of the total length of the internal electrode layer 12 along a lamination interface 11 to the total length of the ceramic layer 10 along the lamination interface 11. The length of the predetermined field of view in the lamination direction is any length in which the ceramic layer 10 and the internal electrode layer 12 in pairs in contact with each other can be seen. The length of the predetermined field of view in a direction perpendicular to the lamination direction is about 10 μm to about 500 μm. Observation is carried out in preferably about five fields of view satisfying the above conditions to calculate an average coverage ratio of the internal electrode layers.

In the present embodiment, the coverage ratio of the internal electrode layers is preferably 90% or more or is more preferably 95% or more.

As described above, the internal electrode layers 12 as a part of the capacitor circuit serve a function of applying voltages to the ceramic layers 10. Thus, materials of the internal electrode layers 12 include a conductive material. Specifically, examples of materials can include Cu, Ni, Ag, Pd, Au, Pt, or an alloy containing at least one of these metal elements. In a situation where a constituent material of the ceramic layers 10 has resistance to reduction, a main component of the conductive material of the internal electrode layers 12 includes preferably Ni and/or a Ni based alloy. Ni contained in the internal electrode layers 12 and Mn contained in localized layers 16 are alloyed to enable improvement of joint strength at the lamination interfaces 11. In this context, the “Ni based alloy” is preferably an alloy containing Ni as a main component and Sn (a Ni—Sn based alloy). Also, the “main component of the conductive material of the internal electrode layers 12” means a component, composed of this main component's constituent element or elements, constituting a total of 80 parts by mol or more out of a total of 100 parts by mol of all constituent elements of the conductive material of the internal electrode layers 12. In a situation where Ni or the Ni based alloy is the main component, at least one internal electrode subcomponent selected from Mn, Cu, Cr, and the like may be contained.

Moreover, the internal electrode layers 12 may contain a ceramic component (e.g., the CSZT based compound) of the ceramic layers 10 as an inhibitor other than the above conductive material or may contain a slight amount (e.g., about 0.1 mass % or less) of non-metal components, such as S and P. The inhibitor prevents or mitigates sintering of the conductive material during a firing process.

The external electrodes 6 may contain any conductive material. For example, a known conductive material (e.g., Ni, Cu, Sn, Ag, Pd, Pt, Au, their alloys, and a conductive resin) is used. The external electrodes 6 have a thickness appropriately determined according to usage or the like. Normally, the thickness is preferably about 1.0 μm to about 100 μm.

FIG. 2 is a schematic sectional view of the element body 4. In the present embodiment, the element body 4 includes the localized layers 16, where Mn is evenly localized in a layer-like manner along the lamination interfaces 11 between the ceramic layers 10 and the internal electrode layers 12.

In the present embodiment, LMn, CMn, and IMn satisfy CMn<LMn and IMn<LMn.

LMn denotes the Mn content of the localized layers 16 in terms of a Mn oxide out of a total of 100 parts by mol Al, Si, Ca, Ti, Mn, Ni, Sr, and Zr in terms of their oxides in the localized layers 16.

CMn denotes the Mn content of the ceramic layers 10 in terms of the Mn oxide out of a total of 100 parts by mol Al, Si, Ca, Ti, Mn, Ni, Sr, and Zr in terms of their oxides in the ceramic layers 10.

IMn denotes the Mn content of the internal electrode layers 12 in terms of the Mn oxide out of a total of 100 parts by mol Al, Si, Ca, Ti, Mn, Ni, Sr, and Zr in terms of their oxides in the internal electrode layers 12.

“In terms of an Al oxide” denotes “in terms of Al₂O₃”.

“In terms of a Si oxide” denotes “in terms of SiO₂”.

“In terms of a Ca oxide” denotes “in terms of CaO”.

“In terms of a Ti oxide” denotes “in terms of TiO₂”.

“In terms of a Mn oxide” denotes “in terms of MnO”.

“In terms of a Ni oxide” denotes “in terms of NiO”.

“In terms of a Sr oxide” denotes “in terms of SrO”.

“In terms of a Zr oxide” denotes “in terms of ZrO₂”.

The localized layers 16 contain Mn most among Al, Mg, Si, and Mn in terms of their oxides.

Note that, it may be that the localized layers 16 are not entirely present at the lamination interfaces 11 or are not present at a part of the lamination interfaces 11.

In a predetermined field of view of a section (Y-Z plane or Z-X plane) parallel to the lamination direction (Z-axis direction) of the element body 4 during observation of one internal electrode layer 12 and one localized layer 16 in pairs in contact with each other, the ratio of the total length of the localized layer 16 in contact with the internal electrode layer 12 along the lamination interface 11 to the total length of the internal electrode layer 12 along the lamination interface 11 is defined as the coverage ratio of the localized layer. Observation is carried out in preferably about five fields of view satisfying the above conditions to calculate an average coverage ratio of the localized layers.

In the present embodiment, the coverage ratio of the localized layers is preferably 80% or more or is more preferably 90% or more.

The localized layers 16 may contain elements other than Mn. The localized layers 16 may contain, for example, Al, Si, Ca, Ti, Ni, Sr, and/or Zr.

In the present embodiment, LMn is preferably 0.5 parts by mol or more and 12.0 parts by mol or less or is more preferably 1.5 parts by mol or more and 5.0 parts by mol or less.

In the present embodiment, LMn/CMn is preferably 1.25 or more and 15.0 or less or is more preferably 1.35 or more and 13.0 or less.

The localized layers 16 have a thickness of preferably 0.1 nm to 14 nm or more preferably 0.15 nm to 6.0 nm in the lamination direction (Z-axis direction). Observation is carried out in preferably about five fields of view satisfying the above conditions to calculate an average thickness of the localized layers 16.

The element body 4 can be analyzed through its sectional observation using, for example, a scanning electron microscope (SEM) or a scanning transmission electron microscope (STEM).

For example, the presence or absence of the localized layers 16 can be measured in an image analysis of a sectional photograph obtained in sectional observation using a SEM, a STEM, or the like. In a situation where a section of the element body 4 is observed in its backscattered electron image obtained using a SEM or its HAADF image obtained using a STEM, a highly dense portion is often identifiable as a bright-contrast portion. In the element body 4, the internal electrode layers 12 tend to be the densest, and the ceramic layers 10 tend to be the second densest. Thus, the internal electrode layers 12 are often identifiable as bright-contrast portions, and the ceramic layers 10 are often identifiable as portions having darker contrast than that of the internal electrode layers 12.

As described above, using lightness contrast found by, for example, binarization of the sectional photograph parallel to the lamination direction of the element body 4, the ceramic layers 10 and the internal electrode layers 12 in the element body 4 can be found.

Based on the above photograph of the section of the element body 4 parallel to the lamination direction, a line analysis from a point “s” of the corresponding ceramic layer 10 to a point “f” of the corresponding internal electrode layer 12 next to the ceramic layer 10 is carried out to identify a portion where Mn is localized near the lamination interface 11. Further, a Mn mapping image of the same field of view where the line analysis is carried out is obtained using STEM-EDS. In the mapping image, a portion where Mn is evenly localized in a layer-like manner along the lamination interface 11 can be identified as the localized layer 16. Using this method, the presence or absence of the localized layer 16, the thickness of the localized layer 16, the coverage ratio of the localized layer, and the like can be found.

The composition of the localized layers 16 can be measured through a component analysis using an electron probe microanalyzer (EPMA) in the sectional observation. The component analysis is carried out preferably at least at three locations to calculate the composition of the localized layers 16, which is an average of the results of measurement. In the present embodiment, when the EPMA is used for the component analysis or the like, an energy dispersive spectroscope (EDS) or a wavelength dispersive spectroscope (WDS) can be used as an X-ray spectroscope.

An example method of manufacturing the multilayer ceramic capacitor 2 shown in FIGS. 1A and 1B is described next.

First, steps of manufacturing the element body 4 are described. In the steps of manufacturing the element body 4, a dielectric paste to be the ceramic layers 10 after firing and an internal electrode paste and a Mn-containing internal electrode paste to be the internal electrode layers 12 after firing are prepared.

The dielectric paste is prepared, for example, as follows. First, dielectric raw materials are uniformly mixed by, for example, wet-mixing and are dried. The resultant mixture is then subject to a heat treatment under predetermined conditions to give a calcined powder. Then, a known organic vehicle or a known water based vehicle is added to the resultant calcined powder, and this mixture is kneaded to prepare the dielectric paste. The dielectric paste obtained in this manner is turned into sheets using, for example, a doctor blade method to give ceramic green sheets. As necessary, the dielectric paste may contain additives selected from various dispersants, plasticizers, dielectrics, subcomponent compounds, glass frit, etc.

The Mn-containing internal electrode paste is prepared by kneading a metal material, a known binder, and a known solvent. The metal material is obtained by mixing a Mn oxide with a conductive material. The Mn oxide is a component contributing to Mn constituting the localized layers 16 after firing. The Mn oxide is, for example, MnO or MnCO₃.

The internal electrode paste is similar to the Mn-containing internal electrode paste except that a metal material of the internal electrode paste contains only a conductive material. That is, the internal electrode paste substantially does not contain a Mn oxide.

Then, on each of the ceramic green sheets, the Mn-containing internal electrode paste is applied in a predetermined pattern using a printing method (e.g., screen printing) or a transfer method to form a Mn-containing internal electrode pattern. Then, on the Mn-containing internal electrode pattern, the internal electrode paste is applied in a predetermined pattern to form an internal electrode pattern. Further, on the internal electrode pattern, the Mn-containing internal electrode paste is applied in a predetermined pattern to form another Mn-containing internal electrode pattern.

That is, on each of the ceramic green sheets, the three-layered internal electrode pattern is formed.

Such ceramic green sheets with the three-layered internal electrode pattern (Mn-containing internal electrode pattern-internal electrode pattern-Mn-containing internal electrode pattern-ceramic green sheet) are laminated, and this laminate is pressed in the lamination direction to give a mother laminated body. Note that the ceramic green sheets, the Mn-containing internal electrode patterns, and the internal electrode patterns are laminated so that, at this time, the ceramic green sheets are located at upper and lower surfaces of the mother laminated body in the lamination direction.

The mother laminated body obtained through the above steps is cut into predetermined dimensions by dicing or push-cutting to give green chips. As necessary, the green chips may be subject to solidification drying to remove plasticizers or the like and may then be subject to barrel polishing using a horizontal centrifugal barrel machine or the like. In barrel polishing, the green chips are put into a barrel together with media and a polishing liquid, and a rotational movement or vibration is applied to the barrel. This removes unwanted parts (e.g., burrs generated during cutting). The green chips after barrel polishing are washed with a cleaning solution (e.g., water) and are dried.

Then, each of the resultant green chips is subject to a binder removal treatment and a firing treatment to give the element body 4. Conditions of the binder removal treatment are appropriately determined according to the composition of the main component of the ceramic layers 10 or the composition of the main component of the internal electrode layers 12 and are not limited. For example, the heating rate is preferably 5° C./hour to 300° C./hour; the holding temperature is preferably 180° C. to 400° C.; and the temperature holding time is preferably 0.5 hours to 24 hours. The binder removal atmosphere is air or a reducing atmosphere.

Conditions of the firing treatment are appropriately determined according to the composition of the main component of the ceramic layers 10 or the composition of the main component of the internal electrode layers 12 and are not limited. For example, the holding temperature during firing is preferably 1200° C. to 1400° C. or is more preferably 1220° C. to 1300° C.; the holding time during firing is preferably 0.5 hours to 8 hours or is more preferably 1 hour to 3 hours; and the heating rate and the cooling rate are preferably 50° C./hour to 500° C./hour. The firing atmosphere is preferably a reducing atmosphere. As an ambient gas, for example, a humidified mixed gas of N₂ and H₂ can be used. Further, in a situation where the internal electrode layers 12 are composed of a base material (e.g., Ni or the Ni based alloy), the oxygen partial pressure of the firing atmosphere is preferably 2.0×10⁻¹³ atm to 1.0×10⁻⁷ atm.

After firing, the resultant element body 4 may be subject to a reoxidation treatment (annealing) as necessary. As for annealing conditions, for example, the oxygen partial pressure is preferably higher than that of firing, and the holding temperature is preferably 1150° C. or less.

In the above binder removal treatment, firing treatment, and annealing treatment, for example, a wetter is used to humidify the N₂ gas, the mixed gas, or the like. In this situation, the water temperature is preferably about 5° C. to about 75° C. The binder removal treatment, firing treatment, and annealing treatment may be carried out continuously or independently.

In the resultant element body 4, the localized layers 16, where Mn is evenly localized in a layer-like manner along the lamination interfaces 11 between the ceramic layers 10 and the internal electrode layers 12, are formed.

End surfaces of the resultant element body 4 are polished, and an external electrode paste is applied there and is baked to form the external electrodes 6. On surfaces of the external electrodes 6, a coating layer is formed by plating or the like as necessary. The above steps give the multilayer ceramic capacitor 2 including the external electrodes 6.

The resultant multilayer ceramic capacitor 2 can be surface-mounted on a substrate (e.g., a printed wiring board) using solder (including molten solder, solder cream, and a solder paste) or a conductive adhesive and is included in various electronics. Alternatively, the multilayer ceramic capacitor 2 can be mounted on a substrate using a wire-shaped leading terminal or a plate-shaped metal terminal.

For including the predetermined localized layers 16 at the lamination interfaces 11, the multilayer ceramic capacitor 2 according to the present embodiment has improved joint strength between the ceramic layers 10 and the internal electrode layers 12 at the lamination interfaces 11. This can prevent or reduce cracks starting at the lamination interfaces 11.

In particular, in a situation where the internal electrode layers 12 contain Ni, Mn contained in the localized layers 16 and Ni contained in the internal electrode layers 12 are readily alloyed. Thus, the localized layers 16, which are formed along the lamination interfaces 11 and contain Mn, and the internal electrode layers 12, which contain Ni, make Mn and Ni be alloyed to enable an increase in the joint strength.

Because an electronic device whose ceramic layers 10 are composed of the CSZT based compound has a lower rate of change of permittivity according to temperature than that of an electronic device whose ceramic layers 10 are composed of barium titanate (hereinafter referred to as “BT based compound”), the former electronic device tends to be used at high frequencies.

In this manner, the ceramic layers 10 composed of the CSZT based compound are preferably used at high frequencies. However, because a difference in linear thermal expansion coefficients between the CSZT based compound and Ni is larger than a difference in linear thermal expansion coefficients between the BT based compound and Ni, provided that the main component of the conductive material of the internal electrode layers 12 is Ni and/or the Ni based alloy, cracks are more likely generated when the main component of the ceramic layers 10 is the CSZT based compound than when the main component of the ceramic layers 10 is the BT based compound.

Further, in a situation where the main component of the ceramic layers 10 is the CSZT based compound, the ceramic layers 10 may contain Mn; and Mn may be contained particularly in the main phase grains 10a composed of the CSZT based compound by being solid-dissolved therein or may be contained in the grain boundary 10b. In the present embodiment, because the localized layers 16 as well contain Mn, Mn contained in the main phase grains 10a and/or the grain boundary 10b or the like of the ceramic layers 10 and Mn contained in the localized layers 16 undergo mutual diffusion. Consequently, the joint strength between the ceramic layers 10 and the localized layers 16 can be increased.

Although one embodiment of the present invention has been described above, the present invention is not limited to the above embodiment and can be variously modified without departing from the gist of the present invention.

While the localized layers 16 are formed using the Mn-containing internal electrode paste in the above embodiment, any method may be used to form the localized layers 16. Other example methods of forming the localized layers 16 include sputtering, vacuum vapor deposition, and chemical vapor deposition (CVD).

In a situation where sputtering is used to form the localized layers 16, one localized layer 16 is formed using sputtering on a ceramic green sheet; an internal electrode pattern is printed on this localized layer 16; and another localized layer 16 is formed on this internal electrode pattern using sputtering. That is, ceramic green sheets each having the internal electrode pattern interposed between two localized layers 16 are laminated, and then this laminate is pressed in the lamination direction to give a mother laminated body. Subsequent steps are similar to those described in the above embodiment.

While the multilayer ceramic capacitor 2 exemplifies an electronic device in the present embodiment, an electronic device of the present invention may be a band-pass filter, a multilayer three-terminal filter, a piezoelectric element, a thermistor, a varistor, etc.

While the ceramic layers 10 and the internal electrode layers 12 are laminated in the Z-axis direction in the present embodiment, the lamination direction may be the X-axis direction or the Y-axis direction. In this situation, the external electrodes 6 are formed according to the exposed surfaces of the internal electrode layers 12. Also, the element body 4 is not necessarily a laminated body and may include a single layer. Moreover, the internal electrode layers 12 may be drawn out to an outer surface of the element body 4 via through-hole electrodes. In this situation, the through-hole electrodes and the external electrodes 6 are electrically connected.

### EXAMPLES

Hereinafter, the present invention is described based on more detailed examples; however, the present invention is not limited to these examples.

### Experiment 1

Experiment 1 relates to Sample Nos. 5 to 9.

In Experiment 1, multilayer ceramic capacitors 2 were manufactured using the following procedure. First, a dielectric paste, a Mn-containing internal electrode paste, and an internal electrode paste were prepared. Using these pastes, green chips were manufactured as described in the description of the embodiment using a sheet method.

At this time, as dielectric raw materials included in the dielectric paste, raw materials having a composition shown in Table 1 were used. Further, as subcomponent compounds contained in the dielectric paste, SiO₂, Al₂O₃, and MnCO₃ were used.

A conductive material of a metal material contained in the Mn-containing internal electrode paste and the internal electrode paste was Ni.

Then, the resultant green chips were subject to a binder removal treatment under conditions described in the description of the embodiment. Then, a firing treatment was carried out to give element bodies 4. As for conditions of the firing treatment, the holding temperature was 1300° C.; the holding time was 2 hours; and the ambient gas was a humidified mixed gas of N₂ and H₂. Then, the element bodies 4 were subject to an annealing treatment under conditions described in the description of the embodiment.

End surfaces of the element bodies 4 obtained as above were polished, and an external electrode paste was applied there and was baked to form external electrodes 6.

In Experiment 1, the respective element bodies 4 of the capacitor samples had a dimension of L0×W0×T0=2.0 mm×1.30 mm×1.30 mm. The number of ceramic layers 10 interposed between internal electrode layers 12 was 80.

From the capacitor samples according to Sample No. 5 of Experiment 1, samples for destructive inspection were extracted; and these samples were subject to sectional observation using a STEM. Specifically, the extracted samples were cut along a Z-X plane, and the resultant sections were mirror polished. Then, using their STEM HAADF images, the average thickness Td of the ceramic layers 10 and the average thickness Te of the internal electrode layers 12 were measured. The results of measurement were as follows.

Average thickness Td of the ceramic layers 10: 2.5 μm

Average thickness Te of the internal electrode layers 12: 1.1 μm

In the above sectional observation, the presence or absence of localized layers 16 was checked; and components of the ceramic layers 10, the internal electrode layers 12, and the localized layers 16 were analyzed using STEM-EDS through point analyses.

Consequently, it was confirmed that the results of measurement of the composition of the ceramic layers 10 approximately corresponded to the results of measurement of the compositions of the dielectric raw materials and the subcomponent compounds contained in the dielectric paste. It was also confirmed that the internal electrode layers 12 contained, as a main component, Ni (conductive material) contained in the internal electrode paste.

Thus, it was presumed that, in each experiment described below, the results of measurement of the composition of the ceramic layers 10 corresponded to the results of measurement of the compositions of the dielectric raw materials and the subcomponent compounds contained in the dielectric paste. It was also presumed that the internal electrode layers 12 contained, as a main component, Ni (conductive material) contained in the internal electrode paste.

Moreover, it was confirmed that, when the Mn-containing internal electrode paste was used, the localized layers 16 contained Mn most among Al, Mg, Si, and Mn in terms of their oxides. Thus, it was presumed that, when the Mn-containing internal electrode paste was used, the localized layers 16 contained Mn most among Al, Mg, Si, and Mn in terms of their oxides.

Table 1 shows the presence or absence of the localized layers. In Tables 1 to 5, “Present” is shown in the “Present or absent” column of the “Localized layer” column when CMn<LMn and IMn<LMn were satisfied and the localized layers contained Mn most among Al, Mg, Si, and Mn in terms of their oxides; and “Absent” is shown in the “Present or absent” column of the “Localized layer” column when the above conditions were not satisfied.

In Tables 1 to 5, the element contained most in the localized layers among Al, Mg, Si, and Mn in terms of their oxides is shown in the “Element” column of the “Localized layer” column.

In all capacitor samples shown in Tables 1 to 5, the coverage ratio of the internal electrode layers was 90% or more.

In Experiment 1, to evaluate the crack occurrence rate of the manufactured capacitor samples in a high-temperature and high-humidity environment, the crack occurrence rate of the samples after a 24-hour pressure cooker test (PCT) and a 168-hour PCT was calculated. The details are provided below.

<Crack Occurrence Rate after 24-Hour PCT>

The capacitor samples were mounted on a FR4 substrate (glass epoxy substrate) using Sn—Ag—Cu solder and were introduced in a pressure cooker tank to conduct an accelerated moisture resistance load test at 121° C. and a humidity of 95% for 24 hours. One hundred capacitor samples were subject to the test. Table 1 shows the number of capacitor samples with cracks. In the present examples, the crack occurrence rate after the 24-hour PCT was preferably 10% or less or was more preferably 3% or less.

<Crack Occurrence Rate after 168-Hour PCT>

The capacitor samples were mounted on a FR4 substrate (glass epoxy substrate) using Sn—Ag—Cu solder and were introduced in a pressure cooker tank to conduct an accelerated moisture resistance load test at 121° C. and a humidity of 95% for 168 hours. One hundred capacitor samples were subject to the test. Table 1 shows the number of capacitor samples with cracks. In the present examples, the crack occurrence rate after the 168-hour PCT was preferably 20% or less or was more preferably 6% or less.

### Experiment 1a

Experiment 1a relates to Sample No. 1. In Experiment 1a, capacitor samples were manufactured as in Experiment 1 except that the internal electrode pattern did not have the three-layer structure and had a single-layer structure including only an internal electrode pattern. The presence or absence of the localized layers was checked, and the crack occurrence rate of the samples after the 24-hour PCT and the 168-hour PCT was calculated. Table 1 shows the results.

That is, in Experiment 1a, no Mn-containing internal electrode pattern was formed using the Mn-containing internal electrode paste.

### Experiment 1b

Experiment 1b relates to Sample No. 2. In Experiment 1b, capacitor samples were manufactured as in Experiment 1 except that, instead of the Mn-containing internal electrode paste, an Al-containing internal electrode paste was used to provide the internal electrode pattern with the three-layer structure. The presence or absence of the localized layers and the corresponding element were determined, and the crack occurrence rate of the samples after the 24-hour PCT and the 168-hour PCT was calculated. Table 1 shows the results.

The Al-containing internal electrode paste was similar to the Mn-containing internal electrode paste except that the Al-containing internal electrode paste contained an Al oxide (Al₂O₃) instead of the Mn oxide.

In Sample No. 2 (Experiment 1b), no localized layer 16 satisfying its definition described above was confirmed; however, because Al was localized in a layer-like manner along lamination interfaces 11, “Present” is shown in the “Present or absent” column of the “Localized layer” column of Table 1, and “Al” is shown in the “Element” column of the “Localized layer” column. That is, in Experiment 1b, in which the Al-containing internal electrode paste was used, it was confirmed that the localized layers 16 contained Al most among Al, Mg, Si, and Mn in terms of their oxides.

### Experiment 1c

Experiment 1c relates to Sample No. 3. In Experiment 1c, capacitor samples were manufactured as in Experiment 1 except that, instead of the Mn-containing internal electrode paste, a Mg-containing internal electrode paste was used to provide the internal electrode pattern with the three-layer structure. The presence or absence of the localized layers and the corresponding element were determined, and the crack occurrence rate of the samples after the 24-hour PCT and the 168-hour PCT was calculated. Table 1 shows the results.

The Mg-containing internal electrode paste was similar to the Mn-containing internal electrode paste except that the Mg-containing internal electrode paste contained a Mg oxide (MgO) instead of the Mn oxide.

In Sample No. 3 (Experiment 1c), no localized layer 16 satisfying its definition described above was confirmed; however, because Mg was localized in a layer-like manner along lamination interfaces 11, “Present” is shown in the “Present or absent” column of the “Localized layer” column of Table 1, and “Mg” is shown in the “Element” column of the “Localized layer” column. That is, in Experiment 1c, in which the Mg-containing internal electrode paste was used, it was confirmed that the localized layers 16 contained Mg most among Al, Mg, Si, and Mn in terms of their oxides.

### Experiment 1d

Experiment 1d relates to Sample No. 4. In Experiment 1d, capacitor samples were manufactured as in Experiment 1 except that, instead of the Mn-containing internal electrode paste, a Si-containing internal electrode paste was used to provide the internal electrode pattern with the three-layer structure. The presence or absence of the localized layers and the corresponding element were determined, and the crack occurrence rate of the samples after the 24-hour PCT and the 168-hour PCT was calculated. Table 1 shows the results.

The Si-containing internal electrode paste was similar to the Mn-containing internal electrode paste except that the Si-containing internal electrode paste contained a Si oxide (SiO₂) instead of the Mn oxide.

In Sample No. 4 (Experiment 1d), no localized layer 16 satisfying its definition described above was confirmed; however, because Si was localized in a layer-like manner along lamination interfaces 11, “Present” is shown in the “Present or absent” column of the “Localized layer” column of Table 1, and “Si” is shown in the “Element” column of the “Localized layer” column. That is, in Experiment 1d, in which the Si-containing internal electrode paste was used, it was confirmed that the localized layers 16 contained Si most among Al, Mg, Si, and Mn in terms of their oxides.

### Experiment 2

Experiment 2 relates to samples of Table 2. In Experiment 2, capacitor samples were manufactured as in Experiment 1 except that the Mn oxide content of the Mn-containing internal electrode paste was changed to change LMn. The presence or absence of the localized layers and the corresponding element were determined, and the crack occurrence rate of the samples after the 24-hour PCT was calculated. Table 2 shows the results of measurement of LMn of each sample of Experiment 2.

### Experiment 3

Experiment 3 relates to samples of Table 3. In Experiment 3, capacitor samples were manufactured as in Experiment 1 except that the Mn oxide content of the dielectric paste was changed to change CMn. The crack occurrence rate of the samples after the 24-hour PCT was calculated. Table 3 shows the results of measurement of LMn and LMn/CMn of each sample of Experiment 3.

### Experiment 4

Experiment 4 relates to samples of Table 4. In Experiment 4, capacitor samples were manufactured as in Experiment 1 except that the application thickness of the Mn-containing internal electrode paste was changed to change the thickness of the localized layers 16. The crack occurrence rate of the samples after the 24-hour PCT was calculated. Table 4 shows the results of measurement of LMn, LMn/CMn, and the thickness of the localized layers of each sample of Experiment 4.

### Experiment 5

Experiment 5 relates to samples of Table 5. In Experiment 5, capacitor samples were manufactured as in Experiment 1 except that the amount of application of the Mn-containing internal electrode paste to a ceramic green sheet was changed to change the amount of adhesion of the Mn-containing internal electrode pattern to the internal electrode pattern to change the coverage ratio of the localized layers. The crack occurrence rate of the samples after the 24-hour PCT was calculated. Table 5 shows the results of measurement of LMn, LMn/CMn, the thickness of the localized layers, and the coverage ratio of the localized layers of each sample of Experiment 5.

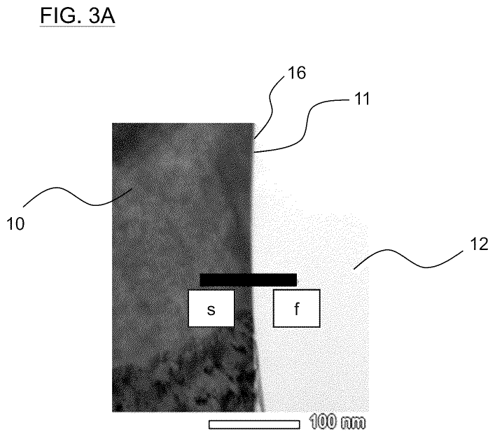

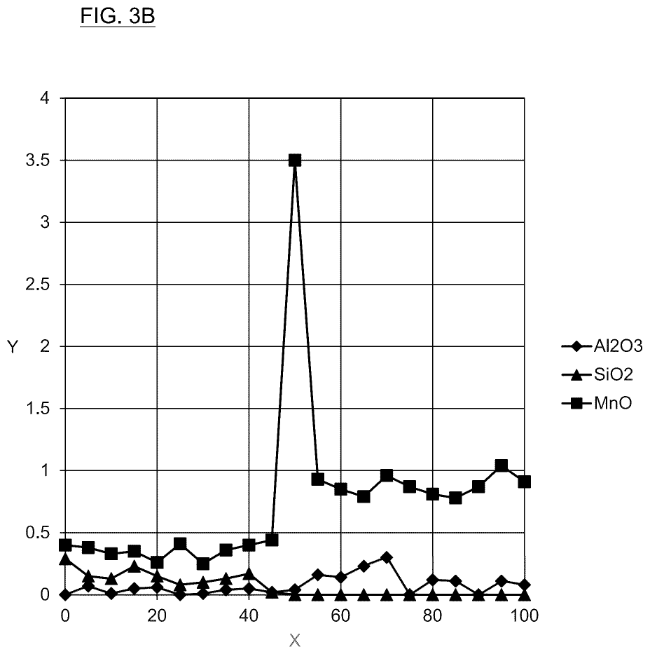

FIGS. 3A and 3B relate to Sample No. 23. FIG. 3A is a STEM HAADF image of the vicinity of a lamination interface 11 of Sample No. 23.

FIG. 3B shows the results of a line analysis from a point “s” of the ceramic layer 10 shown in FIG. 3A to a point “f” of the internal electrode layer 12 next to the ceramic layer 10 along a black line. The X-axis of FIG. 3B represents locations between the points “s” and “f”, and the unit is in nm. That is, the point “s” is at a 0-nm location on the X-axis, and the point “f” is at a 100-nm location on the X-axis.

The Y-axis of FIG. 3B represents, out of a total of 100 parts by mol Al, Si, Ca, Ti, Mn, Ni, Sr, and Zr in terms of their oxides, the element contents in terms of their oxides.

In FIG. 3B, ● represents the Al content in terms of its oxide (in terms of Al₂O₃), ▴ represents the Si content in terms of its oxide (in terms of SiO₂), and ▪ represents the Mn content in terms of its oxide (in terms of MnO).

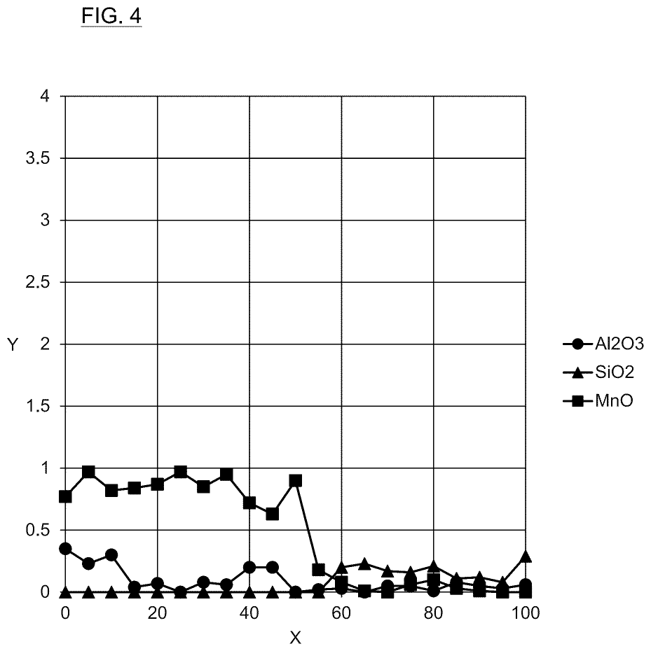

FIG. 4 relates to Sample No. 1. FIG. 4 shows the results of a line analysis from a point “s” of a ceramic layer to a point “f” of an internal electrode layer next to the ceramic layer. The X-axis of FIG. 4 represents locations between the points “s” and “f”, and the unit is in nm. That is, the point “s” is at a 0-nm location on the X-axis, and the point “f” is at a 100-nm location on the X-axis.

The Y-axis of FIG. 4 represents, out of a total of 100 parts by mol Al, Si, Ca, Ti, Mn, Ni, Sr, and Zr in terms of their oxides, the element contents in terms of their oxides.

In FIG. 4, ● represents the Al content in terms of its oxide (in terms of Al₂O₃), ▴ represents the Si content in terms of its oxide (in terms of SiO₂), and ▪ represents the Mn content in terms of its oxide (in terms of MnO).

TABLE 1
Table 1

| | | | Internal | Localized layer | | Crack occurrence rate | |
|---|---|---|---|---|---|---|---|
| | | Dielectric layer | electrode layer | Present | | After | After |
| Sample | Manufacturing | Composition of main | Main | or | | 24-hour | 168-hour |
| No. | method | component | component | absent | Element | PCT | PCT |
| 1 | Experiment 1a | (Ca_{0.7}Sr_{0.3})(Zr_{0.97}Ti_{0.03})O₃ | Ni | Absent | | 25/100 | 52/100 |
| 2 | Experiment 1b | (Ca_{0.7}Sr_{0.3})(Zr_{0.97}Ti_{0.03})O₃ | Ni | Present | Al | 12/100 | 34/100 |
| 3 | Experiment 1c | (Ca_{0.7}Sr_{0.3})(Zr_{0.97}T_{10.03})O₃ | Ni | Present | Mg | 17/100 | 40/100 |
| 4 | Experiment 1d | (Ca_{0.7}Sr_{0.3})(Zr_{0.97}Ti_{0.03})O₃ | Ni | Present | Si | 15/100 | 31/100 |
| 5 | Experiment 1 | (Ca_{0.7}Sr_{0.3})(Zr_{0.75}Ti_{0.25})O₃ | Ni | Present | Mn | 7/100 | 19/100 |
| 6 | Experiment 1 | (Ca_{0.7}Sr_{0.3})(Zr_{0.85}Ti_{0.15})O₃ | Ni | Present | Mn | 0/100 | 0/100 |
| 7 | Experiment 1 | (Ca_{0.7}Sr_{0.3})(Zr_{0.97}Ti_{0.03})O₃ | Ni | Present | Mn | 0/100 | 0/100 |
| 8 | Experiment 1 | CaZrO₃ | Ni | Present | Mn | 0/100 | 0/100 |
| 9 | Experiment 1 | BaTiO₃ | Ni | Present | Mn | 16/100 | 27/100 |

TABLE 2
Table 2

| | | | | | | | Crack |
|---|---|---|---|---|---|---|---|
| | | | | | | | occurrence |
| | | | Internal | Localized layer | | | rate |
| | | Dielectric layer | electrode layer | Present | | LMn | After |
| Sample | Manufacturing | Composition of main | Main | or | | [parts by | 24-hour |
| No. | method | component | component | absent | Element | mol] | PCT |
| 21 | Experiment 2 | (Ca_{0.7}Sr_{0.3})(Zr_{0.97}Ti_{0.03})O₃ | Ni | Present | Mn | 0.10 | 8/100 |
| 22 | Experiment 2 | (Ca_{0.7}Sr_{0.3})(Zr_{0.97}Ti_{0.03})O₃ | Ni | Present | Mn | 0.55 | 0/100 |
| 7 | Experiment 1 | (Ca_{0.7}Sr_{0.3})(Zr_{0.97}Ti_{0.03})O₃ | Ni | Present | Mn | 2.59 | 0/100 |
| 23 | Experiment 2 | (Ca_{0.7}Sr_{0.3})(Zr_{0.97}Ti_{0.03})O₃ | Ni | Present | Mn | 3.50 | 0/100 |
| 24 | Experiment 2 | (Ca_{0.7}Sr_{0.3})(Zr_{0.97}Ti_{0.03})O₃ | Ni | Present | Mn | 5.02 | 0/100 |
| 25 | Experiment 2 | (Ca_{0.7}Sr_{0.3})(Zr_{0.97}Ti_{0.03})O₃ | Ni | Present | Mn | 12.40 | 7/100 |

TABLE 3
Table 3

| | | | | | | | | Crack |
|---|---|---|---|---|---|---|---|---|
| | | | | | | | | occurrence |
| | | | Internal | Localized layer | | | | rate |
| | | Dielectric layer | electrode layer | Present | | LMn | | After |
| Sample | Manufacturing | Composition of main | Main | or | | [parts by | LMn/ | 24-hour |
| No. | method | component | component | absent | Element | mol] | CMn | PCT |
| 31 | Experiment 3 | (Ca_{0.7}Sr_{0.3})(Zr_{0.97}Ti_{0.03})O₃ | Ni | Present | Mn | 2.9 | 1.10 | 6/100 |
| 7 | Experiment 1 | (Ca_{0.7}Sr_{0.3})(Zr_{0.97}Ti_{0.03})O₃ | Ni | Present | Mn | 2.5 | 1.25 | 0/100 |
| 32 | Experiment 3 | (Ca_{0.7}Sr_{0.3})(Zr_{0.97}Ti_{0.03})O₃ | Ni | Present | Mn | 2.6 | 2.53 | 0/100 |
| 33 | Experiment 3 | (Ca_{0.7}Sr_{0.3})(Zr_{0.97}Ti_{0.03})O₃ | Ni | Present | Mn | 2.8 | 5.55 | 0/100 |
| 34 | Experiment 3 | (Ca_{0.7}Sr_{0.3})(Zr_{0.97}Ti_{0.03})O₃ | Ni | Present | Mn | 2.7 | 14.9 | 0/100 |
| 35 | Experiment 3 | (Ca_{0.7}Sr_{0.3})(Zr_{0.97}Ti_{0.03})O₃ | Ni | Present | Mn | 2.5 | 20.3 | 7/100 |

TABLE 4
Table 4

| | | | | | | | | | Crack |
|---|---|---|---|---|---|---|---|---|---|
| | | | | | | | | | occurrence |
| | | | Internal | Localized layer | | | | | rate |
| | | Dielectric layer | electrode layer | Present | | LMn | | | After |
| Sample | Manufacturing | Composition of main | Main | or | | [parts by | LMn/ | Thickness | 24-hour |
| No. | method | component | component | absent | Element | mol] | CMn | [nm] | PCT |
| 41 | Experiment 4 | (Ca_{0.7}Sr_{0.3})(Zr_{0.97}Ti_{0.03})O₃ | Ni | Present | Mn | 2.8 | 1.86 | 0.05 | 8/100 |
| 42 | Experiment 4 | (Ca_{0.7}Sr_{0.3})(Zr_{0.97}Ti_{0.03})O₃ | Ni | Present | Mn | 2.8 | 1.57 | 0.17 | 0/100 |
| 7 | Experiment 1 | (Ca_{0.7}Sr_{0.3})(Zr_{0.97}Ti_{0.03})O₃ | Ni | Present | Mn | 2.9 | 1.61 | 2.5 | 0/100 |
| 43 | Experiment 4 | (Ca_{0.7}Sr_{0.3})(Zr_{0.97}Ti_{0.03})O₃ | Ni | Present | Mn | 2.9 | 1.34 | 5.9 | 0/100 |
| 44 | Experiment 4 | (Ca_{0.7}Sr_{0.3})(Zr_{0.97}Ti_{0.03})O₃ | Ni | Present | Mn | 2.6 | 1.92 | 15 | 5/100 |

TABLE 5
Table 5

| | | | | Localized layer | | | | | | Crack |
|---|---|---|---|---|---|---|---|---|---|---|
| | | | | | | | | | Coverage | occurrence |
| | | | Internal | | | | | | ratio of | rate |
| | | Dielectric layer | electrode layer | Present | | LMn | | | localized | After |
| Sample | Manufacturing | Composition of main | Main | or | | [parts by | LMn/ | Thickness | layer | 24-hour |
| No. | method | component | component | absent | Element | mol] | CMn | [nm] | [%] | PCT |
| 51 | Experiment 5 | (Ca_{0.7}Sr_{0.3})(Zr_{0.97}Ti_{0.03})O₃ | Ni | Present | Mn | 2.8 | 1.78 | 2.05 | 70.03 | 5/100 |
| 52 | Experiment 5 | (Ca_{0.7}Sr_{0.3})(Zr_{0.97}Ti_{0.03})O₃ | Ni | Present | Mn | 2.6 | 1.99 | 2.00 | 81.58 | 0/100 |
| 7 | Experiment 1 | (Ca_{0.7}Sr_{0.3})(Zr_{0.97}Ti_{0.03})O₃ | Ni | Present | Mn | 2.9 | 1.80 | 2.59 | 90.36 | 0/100 |
| 53 | Experiment 5 | (Ca_{0.7}Sr_{0.3})(Zr_{0.97}Ti_{0.03})O₃ | Ni | Present | Mn | 2.9 | 2.28 | 2.70 | 95.85 | 0/100 |

In a situation where the element bodies did not include the localized layers, where Mn was localized in a layer-like manner along the lamination interfaces between the dielectric layers and the internal electrode layers (Sample Nos. 1 to 4), the crack occurrence rate of the samples after the 24-hour PCT was 12% or more, and the crack occurrence rate of the samples after the 168-hour PCT was 31% or more.

In a situation where the main component of the dielectric layers did not include Ca and/or Sr or Zr (Sample No. 9), the crack occurrence rate of the samples after the 24-hour PCT was 16%, and the crack occurrence rate of the samples after the 168-hour PCT was 27%.

In contrast, in a situation where the main component of the dielectric layers included Ca and/or Sr and Zr and the element bodies included the localized layers, where Mn was localized in a layer-like manner along the lamination interfaces between the ceramic layers and the internal electrode layers (Sample Nos. 6 to 8), the crack occurrence rate of the samples after the 24-hour PCT was 0%, and the crack occurrence rate of the samples after the 168-hour PCT was 0%.

Therefore, an effect of preventing or reducing cracks in a high-temperature and high-humidity environment was confirmed when the main component of the dielectric layers included Ca and/or Sr and Zr and the element bodies included the localized layers, where Mn was localized in a layer-like manner along the lamination interfaces between the ceramic layers and the internal electrode layers.

### REFERENCE NUMERALS

2 . . . multilayer ceramic capacitor
4 . . . element body
10 . . . ceramic layer (dielectric layer)
10a . . . main phase grain
10b . . . grain boundary
11 . . . lamination interface
12 . . . internal electrode layer
12a . . . electrode discontinuous portion
16 . . . localized layer
6 . . . external electrode

What is claimed is:

1. An electronic device comprising:
an element body comprising a ceramic layer and an internal electrode layer being laminated,
wherein
the ceramic layer comprises a main component including Ca and/or Sr and Zr; and
the element body comprises a localized layer where Mn is localized in a layer-like manner along a lamination interface between the ceramic layer and the internal electrode layer.

2. The electronic device according to claim 1, wherein LMn, CMn, and IMn satisfy CMn<LMn and IMn<LMn, where
LMn denotes a Mn content of the localized layer in terms of a Mn oxide out of a total of 100 parts by mol Al, Si, Ca, Ti, Mn, Ni, Sr, and Zr in terms of their oxides in the localized layer,
CMn denotes a Mn content of the ceramic layer in terms of the Mn oxide out of a total of 100 parts by mol Al, Si, Ca, Ti, Mn, Ni, Sr, and Zr in terms of their oxides in the ceramic layer, and
IMn denotes a Mn content of the internal electrode layer in terms of the Mn oxide out of a total of 100 parts by mol Al, Si, Ca, Ti, Mn, Ni, Sr, and Zr in terms of their oxides in the internal electrode layer.

3. The electronic device according to claim 1, wherein the localized layer comprises Mn most among Al, Mg, Si, and Mn in terms of their oxides.

4. The electronic device according to claim 1, wherein LMn is 0.5 parts by mol or more and 12.0 parts by mol less, where LMn denotes a Mn content of the localized layer in terms of a Mn oxide out of a total of 100 parts by mol Al, Si, Ca, Ti, Mn, Ni, Sr, and Zr in terms of their oxides in the localized layer.

5. The electronic device according to claim 1, wherein LMn/CMn is 1.25 or more and 15.0 or less, where
LMn denotes a Mn content of the localized layer in terms of a Mn oxide out of a total of 100 parts by mol Al, Si, Ca, Ti, Mn, Ni, Sr, and Zr in terms of their oxides in the localized layer, and
CMn denotes a Mn content of the ceramic layer in terms of the Mn oxide out of a total of 100 parts by mol Al, Si, Ca, Ti, Mn, Ni, Sr, and Zr in terms of their oxides in the ceramic layer.

6. The electronic device according to claim 1, wherein the localized layer has a thickness of 0.1 nm to 14 nm.

7. The electronic device according to claim 1, wherein
a coverage ratio of the localized layer is 80% or more; and
the coverage ratio of the localized layer denotes a ratio of a total length of the localized layer in contact with the internal electrode layer along the lamination interface to a total length of the internal electrode layer along the lamination interface in a predetermined field of view of a section parallel to a lamination direction of the element body during observation of the internal electrode layer and the localized layer in pairs in contact with each other.

8. The electronic device according to claim 1, wherein
a coverage ratio of the internal electrode layer is 90% or more; and
the coverage ratio of the internal electrode layer denotes a ratio of a total length of the internal electrode layer along the lamination interface to a total length of the ceramic layer along the lamination interface in a predetermined field of view of a section parallel to a lamination direction of the element body during observation of the ceramic layer and the internal electrode layer in pairs in contact with each other.

9. The electronic device according to claim 1, wherein a main component of a conductive material included in the internal electrode layer comprises Ni and/or a Ni based alloy.

10. The electronic device according to claim 1, wherein
the ceramic layer comprises a perovskite-type compound having a main component represented by a formula ABO₃; and
the perovskite-type compound comprises a compound representable by a composition formula (Ca₁₋ₓSrₓ)ₘ(Zr_{1-y-z}Ti_{y}Hf_{z})O₃, where
m ranges from 0.9 to 1.1,
x satisfies 0≤x≤1, and
y and z satisfy 0.80≤1−y−z≤1.0.
